(19) United States
(12) Patent Application Publication
(10) Pub. No.: US 2026/0259634 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Seikou ABE, Osaka (JP)

(73) Assignee: PANASONIC INTELLECTUAL PROPERTY MANAGEMENT CO., LTD., Osaka (JP)

(21) Appl. No.: 19/655,386

(22) Filed: Apr. 22, 2026

Related U.S. Application Data
(63) Continuation of application No. PCT/JP2024/038767, filed on Oct. 30, 2024.
(60) Provisional application No. 63/546,996, filed on Nov. 2, 2023.

(30) Foreign Application Priority Data
Jun. 18, 2024 (JP) 2024-097927

(51) Int. Cl. G06F 3/04815; G06F 3/04817; G06T 11/60

(52) U.S. Cl. CPC G06F 3/04815; G06F 3/04817; G06T 11/60

(57) ABSTRACT

An information processing method includes: displaying a bird’s-eye view on a display of an information terminal; and displaying, in the bird’s-eye view, a plurality of photographing spot icons respectively indicating a plurality of photographing spots being continuous in a series from a photographing start spot to a photographing finish spot. The displaying of the photographing spot icons includes, in a case where the bird’s-eye view shows first multiple photographing spots and second multiple photographing spots related to photographing executed earlier than a photographing date and time concerning each of the first multiple photographing spots, displaying third multiple photographing spot icons respectively indicating third multiple photographing spots each belonging to the first multiple photographing spots and falling within a predetermined range from each of the second multiple photographing spots in a route from the photographing start spot to the photographing finish spot.

### FIELD OF INVENTION

The present disclosure relates to a technology of displaying an image.

### BACKGROUND ART

For instance, Patent Literature 1 discloses a technology of a system configured to: designate a desired location shown in construction drawing data being displayed: give a photographing instruction to capture an image of a construction site serving as the designated desired location; and associate arrangement data related to the image of the construction site photographed on the basis of the photographing instruction with the designated desired location shown in the construction drawing data; and display and put the arrangement data on the construction drawing data.

Unfortunately, in the conventional technology, such a location to be photographed is determined in advance, and an image is captured only at the determined location. Therefore, the conventional technology fails to continuously capture a plurality of images, and has no consideration for a disadvantage of an increase in an image data amount.

Patent Literature 1: International Unexamined Patent Publication No. 2022/145021

### SUMMARY OF THE INVENTION

This disclosure has been accomplished to overcome the disadvantage described above, and has an object of providing a technology to achieve a reduction in an image data amount.

An information processing method according to an aspect of the present disclosure is an information processing method to be executed by a computer, and includes: displaying a bird’s-eye view on a display of an information terminal; and displaying, in the bird’s-eye view, a plurality of photographing spot icons respectively indicating a plurality of photographing spots being continuous in a series from a photographing start spot to a photographing finish spot. The photographing spot icons are respectively associated with a plurality of images captured at the photographing spots. The displaying of the photographing spot icons includes, in a case where the bird’s-view shows first multiple photographing spots and second multiple photographing spots related to photographing executed earlier than a photographing date and time concerning each of the first multiple photographing spots, displaying third multiple photographing spot icons respectively indicating third multiple photographing spots each belonging to the first multiple photographing spots and falling within a predetermined range from each of the second multiple photographing spots in a route from the photographing start spot to the photographing finish spot.

This disclosure achieves a reduction in an image data amount.

### BRIEF DESCRIPTION OF THE DRAWINGS

FIG. 1 is diagram showing an overall configuration of an information processing system in an embodiment.

FIG. 2 is a flowchart showing an example of a process by a communication device in the embodiment.

FIG. 3 is a first flowchart showing an example of an image reduction process by a server in the embodiment.

FIG. 4 is a second flowchart showing an example of the image reduction process by the server in the embodiment.

FIG. 5 illustrates a design drawing in which second multiple photographing spot icons are drawn in the embodiment.

FIG. 6 illustrates the design drawing in which first multiple photographing spot icons and the second multiple photographing spot icons are drawn in the embodiment.

FIG. 7 shows third multiple photographing spot icons extracted from the first multiple photographing spot icons on the basis of the second multiple photographing spot icons in the embodiment.

FIG. 8 illustrates an example display screen image to receive a change from a selected image corresponding to one photographing spot icon having been selected.

FIG. 9 is a flowchart showing an example of an image displaying process by the server in the embodiment.

### DETAILED DESCRIPTION

Knowledge forming the basis of the present disclosure A user interface has been developed to display, in a two-dimensional design drawing for a worksite or other site, a plurality of photographing spot icons respectively indicating photographing spots where the worksite is actually photographed, and to display an image captured at a certain photographing spot indicated by corresponding one photographing spot icon in response to selection of the one photographing spot icon. This configuration allows a manager of the worksite to grasp a situation of the worksite without visiting the worksite.

A photographing person moves on the worksite while photographing the worksite with a photographing device. The photographing device captures a plurality of images at a predetermined frame rate for a period from start of photographing to finish of the photographing. At this time, if the photographing person walks slowly or stops, a large amount of multiple similar images may be stored, and hence, an image data amount may increase.

In the conventional technology described above, a location to be photographed is determined in advance, and an image is captured only at the determined location. Therefore, the conventional technology fails to continuously capture a plurality of images, and has no consideration for a disadvantage of an increase in an image data amount.

The following technologies will be disclosed to overcome the disadvantage.

(1) An information processing method according to an aspect of the disclosure is an information processing method to be executed by a computer, and includes: displaying a bird’s-eye view on a display of an information terminal; and displaying, in the bird’s-eye view, a plurality of photographing spot icons respectively indicating a plurality of photographing spots being continuous in a series from a photographing start spot to a photographing finish spot. The photographing spot icons are respectively associated with a plurality of images captured at the photographing spots. The displaying of the photographing spot icons includes, in a case where the bird’s-eye view shows first multiple photographing spots and second multiple photographing spots related to photographing executed earlier than a photographing date and time concerning each of the first multiple photographing spots, displaying third multiple photographing spot icons respectively indicating third multiple photographing spots each belonging to the first multiple photographing spots and falling within a predetermined range from each of the second multiple photographing spots in a route from the photographing start spot to the photographing finish spot.

This configuration includes, in a case where the bird’s-eye view shows the first multiple photographing spots and the second multiple photographing spots related to photographing executed earlier than a photographing date and time concerning each of the first multiple photographing spots, maintaining third multiple images captured at third multiple photographing spots each belonging to the first multiple photographing spots and falling within a predetermined range from each of the second multiple photographing spots in a route from the photographing start spot to the photographing finish spot, and deleting other image captured at other photographing spot, and thus achieves a reduction in an image data amount.

(2) In the information processing method according to (1) above, the displaying of the photographing spot icons may include drawing, in the bird’s-eye view, first multiple photographing spot icons respectively indicating the first multiple photographing spots and second multiple photographing spot icons respectively indicating the second multiple photographing spots, and displaying only third multiple photographing spot icons each belonging to the first multiple photographing spot icons and overlapping each of the second multiple photographing spot icons in the route from the photographing start spot to the photographing finish spot.

This configuration includes: maintaining only third multiple images respectively corresponding to third multiple photographing spot icons each belonging to the first multiple photographing spot icons and overlapping each of the second multiple photographing spot icons in the route from the photographing start spot to the photographing finish spot; and deleting other image corresponding to other photographing spot icon, and thus achieves the reduction in the image data amount.

(3) In the information processing method according to (2) above, the displaying of the photographing spot icons may include displaying only third multiple photographing spot icons each belonging to the first multiple photographing spot icons, and each overlapping each of the second multiple photographing spot icons and having a largest overlapping area therewith in the route from the photographing start spot to the photographing finish spot.

This configuration includes: maintaining only third multiple images respectively corresponding to third multiple photographing spot icons each belonging to the first multiple photographing spot icons, and each overlapping each of the second multiple photographing spot icons in the route from the photographing start spot to the photographing finish spot and having a largest overlapping area therewith; and deleting other image corresponding to other photographing spot icon, and thus achieves a reduction in the image data amount.

(4) In the information processing method in (1) above, the displaying of the photographing spot icons may include displaying third multiple photographing spot icons respectively indicating only third multiple photographing spots each belonging to the first multiple photographing spots and being closest to each of the second multiple photographing spots in the route from the photographing start spot to the photographing finish spot.

This configuration includes: maintaining only third multiple images respectively captured at the third multiple photographing spots each belonging to the first multiple photographing spots and being closest to each of the second multiple photographing spots in the route from the photographing start spot to the photographing finish spot; and deleting other image captured at other photographing spot, and thus achieves a reduction in the image data amount.

(5) The information processing method according to any one of (1) to (4) above may further include storing, in a memory, only third multiple images each belonging to first multiple images respectively captured at the first multiple photographing spots, the third multiple images being respectively captured at the third multiple photographing spots each falling within the predetermined range from each of the second multiple photographing spots in the route from the photographing start spot to the photographing finish spot, and deleting other image.

This configuration includes: storing, in the memory, only third multiple images each belonging to the first multiple images respectively captured at the first multiple photographing spots, the third multiple images being respectively captured at the third multiple photographing spots each falling within the predetermined range from each of the second multiple photographing spots in the route from the photographing start spot to the photographing finish spot; and deleting other image, and thus achieves a reduction in the image data amount.

(6) The information processing method according to any one of (1) to (4) above may further include: making copies of first multiple images respectively captured at the first multiple photographing spots; and storing, in a memory, only third multiple images each included in the copies of the first multiple images and respectively captured at the third multiple photographing spots each falling within the predetermined range from each of the second multiple photographing spots in the route from the photographing start spot to the photographing finish spot, and deleting other image.

This configuration includes deleting other image from the copies of the first multiple images, and thus enables modification of the first multiple images by using originals of the first multiple images when the modification to the first multiple images is required.

(7) The information processing method according to any one of (1) to (6) above may further include: creating, in a case where a change in at least one of the photographing start spot and the photographing finish spot by a user is received, first multiple photographing spots being continuous in a series from a photographing start spot to a photographing finish spot in the bird’s-eye view, on the basis of the bird’s-eye view, the images, the photographing start spot resulting from the received change, and the photographing finish spot resulting from the received change.

If the user registers wrong places or positions as the photographing start spot and the photographing finish spot respectively, a trace of the first multiple photographing spots may deviate from an actual trace In this regard, in the case where a change in at least one of the photographing start spot and the photographing finish spot by the user is received, first multiple photographing spots are created on the basis of the bird’s-eye view, the images, the photographing start spot resulting from the received change, and the photographing finish spot resulting from the received change. This configuration thus enables modification of the deviation in the trace of the first multiple photographing spots.

(8) The information processing method according to any one of (1) to (7) may further include: displaying, in a case where selection of one photographing spot icon by the user from among the third multiple photographing spot icons being displayed is received, a selected image corresponding to the selected one photographing spot icon, a first candidate image captured before the selected image, and a second candidate image captured after the selected image; and changing, in a case where an instruction to change the selected image to the first candidate image or the second candidate image is received, the selected image corresponding to the one photographing spot icon to the first candidate image or the second candidate image.

An image associated with each of third multiple photographing spots resulting from reduction may deviate from an image captured at the same photographing spot in past. In this regard, in the case where an instruction to change a selected image corresponding to one photographing spot icon to a first candidate image captured before the selected image or a second candidate image captured after the selected image is received, the selected image corresponding to the one photographing spot icon is changed to the first candidate image or the second candidate image. Thus, the configuration enables association of the one photographing spot icon with an optimal image.

Moreover, the disclosure can be realized as: the information processing method executing the above-described distinctive ways; and a information processing device including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(9) An information processing device according to another aspect of the disclosure includes a processor. The processor is configured to: display a bird’s-eye view on a display of an information terminal; and display, in the bird’s-eye view, a plurality of photographing spot icons respectively indicating a plurality of photographing spots being continuous in a series from a photographing start spot to a photographing finish spot. The photographing spot icons are respectively associated with a plurality of images captured at the photographing spots. In the displaying of the photographing spot icons, in a case where the bird’s-eye view shows first multiple photographing spots and second multiple photographing spots related to photographing executed earlier than a photographing date and time concerning each of the first multiple photographing spots, third multiple photographing spot icons are displayed, the third multiple photographing spot icons respectively indicating third multiple photographing spots each belonging to the first multiple photographing spots and falling within a predetermined range from each of the second multiple photographing spots in a route from the photographing start spot to the photographing finish spot.

(10) An information processing program according to another aspect of the present disclosure includes causing a computer to: display a bird’s-eye view on a display of an information terminal; and display, in the bird’s-eye view, a plurality of photographing spot icons indicating a plurality of photographing spots being continuous in a series from a photographing start spot to a photographing finish spot. The photographing spot icons are respectively associated with a plurality of images captured at the photographing spots. In the displaying of the photographing spot icons, in a case where the bird’s-eye view shows first multiple photographing spots and second multiple photographing spots related to photographing executed earlier than a photographing date and time concerning each of the first multiple photographing spots, third multiple photographing spot icons are displayed, the third multiple photographing spot icons respectively indicating third multiple photographing spots each belonging to the first multiple photographing spots and falling within a predetermined range from each of the second multiple photographing spots in a route from the photographing start spot to the photographing finish spot.

(11) A non-transitory computer readable recording medium according to another aspect of the present disclosure stores an information processing program described in (10) above.

An embodiment of this disclosure will be described with reference to the accompanying drawings. The embodiment which will be described below represents a specific example of the disclosure. Numeric values, shapes, constituent elements, steps, and the order of the steps described below in the embodiment are mere examples, and thus should not be construed to delimit the disclosure. Moreover, constituent elements which are not recited in the independent claims each showing the broadest concept among the constituent elements in the embodiment are described as selectable constituent elements. The respective contents are combinable with each other in all the embodiments.

### Embodiment

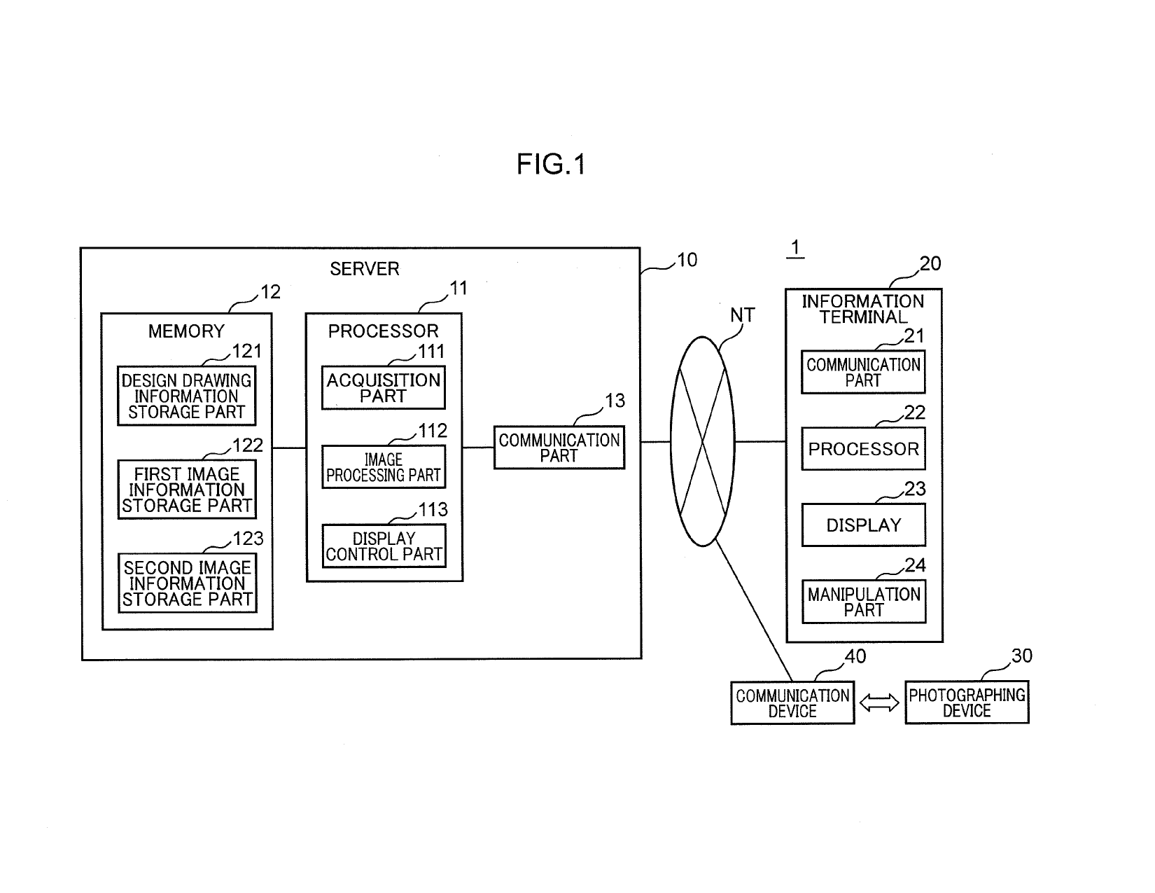

FIG. 1 is diagram showing an overall configuration of an information processing system 1 in an embodiment.

The information processing system 1 is configured to display a bird’s-eye view for a workspace on a display 23 of an information terminal 20, and display, in the bird’s-eye view, a plurality of photographing spot icons respectively indicating a plurality of photographing spots being continuous in a series from a photographing start spot to a photographing finish spot. The information processing system 1 includes a server 10, the information terminal 20, a photographing device 30, and a communication device 40.

The server 10 is an example of an information processing device and a computer. The server 10, the information terminal 20, and the communication device 40 are communicably connected to one another via a network NT. The network NT includes, for example, the internet. The server 10 includes, for example, a cloud server including one or more computers. However, this is a mere example, and the server 10 may include an edge server, or may be mounted to the information terminal 20. A configuration in which the server 10 is mounted to the information terminal 20 corresponds to an example configuration of the information terminal 20 in the form of an information processing device.

The information terminal 20 is carriable by a user. The user is, for example, a manager of a predetermined space to be photographed by the photographing device 30. The predetermined space is, for example, a construction site. However, this is a mere example, and the predetermined space may be a worksite, a factory, a shop or store, or an office. The information terminal 20 may include a portable computer, e.g., a smartphone or a tablet computer, or may include a stationary computer. The information terminal 20 is configured to display an image on the display 23 under control by the server 10. Although FIG. 1 shows an example of one information terminal 20, a plurality of information terminals may be connected to the server 10 via the network NT. The information terminal 20 includes a communication part 21, a processor 22, the display 23, and a manipulation part 24.

The communication part 21 includes a communication interface that connects the information terminal 20 to the network NT. The communication part 21 is configured to send, to the server 10, instruction signals respectively indicating various instructions which the manipulation part 24 receives from the user. The communication part 21 is configured to receive, from the server 10, display data to display various display screen images.

The processor 22 includes, for example, a central processing unit (CPU), and causes the display 23 to display a display screen image indicated by the display data received by the communication part 21.

The display 23 includes, for example, various display devices, e.g., liquid crystal displays or organic Electro-Luminescence (EL) displays, to display various display screen images under control by the processor 22.

The manipulation part 24 includes, for example, a keyboard, a touch screen, and a mouse, and is configured to receive various instructions input by the user.

The communication device 40 includes a mobile information terminal, e.g., a smartphone or a tablet computer, and connects the photographing device 30 to the network NT. The communication device 40 and the photographing device 30 are communicably connected to each other via a near field communication channel, such as the Bluetooth (registered trademark).

The photographing device 30 includes, for example, an omnidirectional camera, and captures an image at a predetermined frame rate. The omnidirectional camera is also referred to as a 360-degree camera, and can acquire an omnidirectional image at 360 degrees. The photographing device 30 is, for example, a portable photographing device carriable by a photographing person. The photographing person is, for example, a worker or a site supervisor on a construction site. The photographing device 30 may execute photographing in a state of being held in a hand of the photographing person or in a state of being attached to a body (e.g., the head) of the photographing person. The photographing device 30 may include a typical camera.

The photographing person moves on the construction site while photographing the construction site with the photographing device 30. The photographing person presses, at a photographing start spot, a photographing button of the photographing device 30 while making a photographing direction of the photographing device 30 agree with the north direction to start photographing, and presses the photographing button again to finish the photographing when reaching a photographing finish spot. When the photographing is finished, the photographing device 30 sends a series of images, i.e., first multiple images, having been captured to the communication device 40.

Each image includes a photographing date and time. For instance, the photographing date and time is acquired by a timepiece included in the photographing device 30. Here, the photographing device 30 is configured to capture an image at a predetermined frame rate (e.g., ten frames per second), and therefore, a photographing spot is defined by a frame periodic unit. However, this leads to a huge amount of data, and thus, the photographing spot may be defined for a predetermined time period (e.g., one second, five seconds, or ten seconds).

The communication device 40 is configured to receive the first multiple images sent from the photographing device 30. The communication device 40 is further configured to display a design drawing for the construction site, and receive designation by the photographing person about a position corresponding to the photographing start spot and a position corresponding to the photographing finish spot in the design drawing.

The photographing start spot and the photographing finish spot are specified in response to input of instruction from the photographing person to designate the position corresponding to each spot in a design drawing screen image of a site displayed on a display of the communication device 40. A two-dimensional coordinate axis is defined in the design drawing screen image. Thus, each of the photographing start spot and the photographing finish spot is defined by a two-dimensional coordinate value. The server 10 uses each of the photographing start spot and the photographing finish spot to specify a position corresponding to each photographing spot and a photographing direction for each image.

The communication device 40 sends, to the server 10 via the network NT, photographing information including the captured first multiple images. The photographing information is generated at every execution of one photographing operation. The one photographing operation means a series of actions from start of photographing to finish of the photographing by a worker carrying the photographing device 30 on the construction site. A plurality of images is captured through the one photographing operation. The photographing information includes the captured first multiple images and meta information about each of the first multiple images. The meta information includes a photographing ID, a photographing date and time, and a design drawing ID. The photographing ID is an identifier to identify a photographing operation. The photographing date and time represents a photographing date and time for each image. The design drawing ID is an identifier to identify a design drawing for a predetermined space corresponding to an image.

The server 10 includes a processor 11, a memory 12, and a communication part 13. The processor 11 includes, for example, a central processing unit (CPU). The processor 11 has an acquisition part 111, an image processing part 112, and an display control part 113. Each of the acquisition part 111, the image processing part 112, and the display control part 113 may come into effect, for example, when the processor 11 executes an information processing program, or may be established in the form of a dedicated hardware circuit, such as an application specific integrated circuit (ASIC). The information processing program may be recorded in a non-transitory computer-readable recording medium.

The communication part 13 includes a communication interface that connects the server 10 to the network NT. The communication part 13 is configured to receive the photographing information sent from the communication device 40. The communication part 13 is configured to receive, from the information terminal 20, instruction signals respectively indicating various instructions received from the user. The communication part 13 is configured to send, to the information terminal 20, display data to display various display screen images.

The memory 12 includes a non-volatile and rewritable storage device, such as a hard disk drive or a solid state drive. The memory 12 includes a design drawing information storage part 121, a first image information storage part 122, and a second image information storage part 123.

The design drawing information storage part 121 stores design drawing information. The design drawing information includes image information indicating a design drawing for a predetermined space. The design drawing information is associated with a design drawing ID to identify the design drawing. The design drawing is an example of a bird’s-eye view. The design drawing represents a drawing of a design for a construction site, and may include a plan view, a blueprint, a map, or a perspective view of the construction site. The bird’s-eye view can be rephrased as an overhead view, that is, a view seen from above, or a view from a high position looking down.

The acquisition part 111 is configured to create first multiple photographing spots being continuous in a series from a photographing start spot to a photographing finish spot in a design drawing, on the basis of the design drawing, the first multiple images, the photographing start spot, and the photographing finish spot. The acquisition part 111 is configured to specify, by employing the Visual Simultaneous Localization and Mapping (SLAM) technique, a position corresponding to a photographing spot for each of the first multiple images from a photographing start spot, a photographing finish spot, and the first multiple images each included in the photographing information received by the communication part 13. Such a position corresponding to the photographing spot is expressed with a two-dimensional coordinate value in the design drawing. The acquisition part 111 further specifies a photographing direction for each of the first multiple images by employing the Visual SLAM technique. The photographing direction for each image is expressed with, for example, a three-dimensional polar coordinate vector.

The acquisition part 111 is configured to generate first image information on the basis of the photographing information and the design drawing received by the communication part 13. The first image information associates first multiple images respectively captured at the first multiple photographing spots to be subjected to reduction and meta information about each of the first multiple images with each other. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image.

The first image information storage part 122 stores the first image information. The acquisition part 111 makes the first image information storage part 122 store the generated first image information.

The second image information storage part 123 stores second image information. The second image information associates second multiple images and meta information about each of the second multiple images with each other, the second multiple images having been captured at second multiple photographing spots earlier than a photographing date and time concerning each of the first multiple photographing spots and resulting from reduction. The number of second multiple photographing spots is smaller than the number of first multiple photographing spots. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image. The second image information is generated by the image processing part 112 to be described later.

The communication part 13 is configured to receive an instruction to designate a photographing date and time from the information terminal 20. The manipulation part 24 of the information terminal 20 receives selection of the photographing date and time by the user, and the communication part 21 sends, to the server 10, an instruction to designate the photographing date and time selected by the user. The instruction to designate the photographing date and time contains a photographing ID.

The acquisition part 111 acquires, from the design drawing information storage part 121, a design drawing corresponding to the design drawing ID contained in the instruction to display the design drawing received by the communication part 13. Moreover, the acquisition part 111 acquires, from the second image information storage part 123, the second multiple photographing spots each corresponding to the photographing ID contained in the instruction to designate the photographing date and time received by the communication part 13.

The acquisition part 111 acquires, after generating the first image information, second image information similar to the first image information from the second image information storage part 123. The “second image information similar to the first image information” means second image information including substantially the same photographing start spot and substantially the same photographing finish spot as the photographing start spot and the photographing finish spot included in the first image information. For instance, the acquisition part 111 acquires, from the second image information storage part 123, second image information including a photographing start spot and a photographing finish spot falling within a predetermined range from the photographing start spot and the photographing finish spot included in the first image information. The predetermined range is defined by, for example, a circle with a radius of two meters.

The acquisition part 111 is configured to determine whether second image information similar to the first image information is present. When no second image information similar to the first image information is present, the image processing part 112 receives selection of an image to remain by the user from among the first multiple images. The image processing part 112 is configured to cause the display 23 to display a design drawing, and display and superimpose, in the design drawing, first multiple photographing spot icons respectively indicating the first multiple photographing spots. The user selects a plurality of photographing spot icons to remain as second multiple photographing spots from among the first multiple photographing spot icons being displayed on the display 23. At this time, the user may select a plurality of photographing spot icons while confirming an image corresponding to each photographing spot icon. The image processing part 112 maintains, as second multiple images, only a plurality of images corresponding to the photographing spot icons selected by the user from among the first multiple images respectively corresponding to the first multiple photographing spot icons, and deletes other image. The image processing part 112 causes the second image information storage part 123 to store second image information associating the second multiple images and meta information about each of the second multiple images with each other.

In contrast, when second image information similar to the first image information is present, the image processing part 112 executes, on the basis of the second multiple photographing spots included in the second image information, reduction with respect to the first multiple images included in the first image information. Specifically, the image processing part 112 causes the second image information storage part 123 of the memory 12 to store only third multiple images each belonging to the first multiple images captured at the first multiple photographing spots and each falling within a predetermined range from each of the second multiple photographing spots in a route from the photographing start spot to the photographing finish spot, and deletes other image.

The image processing part 112 draws, in the design drawing, first multiple photographing spot icons respectively indicating first multiple photographing spots and second multiple photographing spot icons respectively indicating second multiple photographing spots. The image processing part 112 causes the second image information storage part 123 of the memory 12 to store only third multiple images respectively corresponding to third multiple photographing spot icons each belonging to the first multiple photographing spot icons and overlapping each of the second multiple photographing spot icons in the route from the photographing start spot to the photographing finish spot, and deletes other image. Specifically, the image processing part 112 causes the second image information storage part 123 of the memory 12 to store only third multiple images respectively corresponding to third multiple photographing spot icons each belonging to the first multiple photographing spot icons, and each overlapping each of the second multiple photographing spot icons in the route from the photographing start spot to the photographing finish spot and having a largest overlapping area therewith, and deletes other image corresponding to other photographing spot icon.

The image processing part 112 makes a copy of the first image information stored in the first image information storage part 122, and thereby makes copies of the first multiple images respectively captured at the first multiple photographing spots. The image processing part 112 causes the second image information storage part 123 of the memory 12 to store only third multiple images each included in the copies of the first multiple images and respectively captured at third multiple photographing spots each falling within a predetermined range from each of the second multiple photographing spots in the route from the photographing start spot to the photographing finish spot, and deletes other image. At this time, the image processing part 112 maintains, in the copies of the first multiple images, only third multiple images respectively corresponding to the third multiple photographing spot icons each belonging to the first multiple photographing spot icons, and each overlapping each of the second multiple photographing spot icons in the route from the photographing start spot to the photographing finish spot and having a largest overlapping area therewith. The image processing part 112 further deletes other image corresponding to other photographing spot icon from the copies of the first multiple images. The image processing part 112 causes the second image information storage part 123 to store the copies of the first multiple images resulting from the reduction as the second multiple images.

Although the acquisition part 111 is configured to determine whether second image information similar to the first image information is present in the embodiment, the present disclosure is not particularly limited thereto. The acquisition part 111 may receive selection by the user about second image information captured at the same place as the generated first image information from among a plurality of pieces of second image information.

The display control part 113 is configured to cause the display 23 of the information terminal 20 to display a design drawing for a workspace. The display control part 113 causes the display 23 of the information terminal 20 to display the design drawing acquired by the acquisition part 111. The display control part 113 is configured to send display data for the design drawing to the information terminal 20 via the communication part 13. The communication part 21 of the information terminal 20 receives the display data sent from the server 10. The display 23 displays the design drawing received by the communication part 21.

The display control part 113 is configured to display, in the design drawing, a plurality of photographing spot icons respectively indicating a plurality of photographing spots being continuous in a series from a photographing start spot to a photographing finish spot. The photographing spot icons are respectively associated with a plurality of images captured at the photographing spots. In a case where second image information similar to the first image information is present, that is, in a case where the design drawing shows first multiple photographing spots and second multiple photographing spots related to photographing executed earlier than a photographing date and time concerning each of the first multiple photographing spots, the display control part 113 is configured to display third multiple photographing spot icons respectively indicating third multiple photographing spots each belonging to the first multiple photographing start spots and falling within a predetermined range from each of the second multiple photographing spots in a route from the photographing start spot to the photographing finish spot. In this case, the display control part 113 avoids displaying a plurality of photographing spot icons respectively indicating a plurality of photographing spots each belonging to the first multiple photographing spots and being outside the predetermined range from each of the second multiple photographing spots in the route from the photographing start spot to the photographing finish spot.

In a case where a current photographing spot falls within a predetermined range from a past photographing spot but a current photographing spot icon is outside a predetermined range or the current photographing spot icon overlaps another photographing spot icon, the display control part 113 may avoid displaying the current photographing spot icon.

The display control part 113 is configured to draw, in the design drawing, first multiple photographing spot icons respectively indicating first multiple photographing spots and second multiple photographing spot icons respectively indicating second multiple photographing spots. The display control part 113 is configured to display only third multiple photographing spot icons each belonging to the first multiple photographing spot icons and overlapping each of the second multiple photographing spot icons in the route from the photographing start spot to the photographing finish spot.

The display control part 113 is configured to display only third multiple photographing spot icons each belonging to the first multiple photographing spot icons, and each overlapping each of the second multiple photographing spot icons in the route from the photographing start spot to the photographing finish spot and having a largest overlapping area therewith.

In the embodiment, each of the photographing start spot and the photographing finish spot is determined through registration of a corresponding position in the design drawing by the user. Therefore, if the user registers wrong places or positions as the photographing start spot and the photographing finish spot respectively, a trace of the first multiple photographing spots may deviate from an actual trace. To avoid such deviation, the display control part 113 may receive a change in at least one of the photographing start spot and the photographing finish spot by the user. In a case where the change in the at least one of the photographing start spot and the photographing finish spot by the user is received, the image processing part 112 may create first multiple photographing spots being continuous in a series from a photographing start spot to a photographing finish spot in the design drawing, on the basis of the design drawing, the first multiple images, the photographing start spot resulting from the received change, and the photographing finish spot resulting from the received change. The image processing part 112 changes the first multiple photographing spots associated with the first multiple images included in the first image information stored in the first image information storage part 122 to the recreated first multiple photographing spots.

The display control part 113 may receive selection of one photographing spot icon by the user from among the third multiple photographing spot icons being displayed. In a case where selection of one photographing spot icon by the user from among the third multiple photographing spot icons being displayed is received, the display control part 113 may be configured to display a selected image corresponding to the selected one photographing spot icon, a first candidate image captured before the selected image, and a second candidate image captured after the selected image. In the embodiment, an image associated with each of third multiple photographing spots resulting from reduction may deviate from an image captured at the same photographing spot in past. Hence, the user may change the selected image corresponding to the one photographing spot icon to the first candidate image or the second candidate image at another frame. The display control part 113 may receive an instruction from the user as to whether to change the selected image to the first candidate image or the second candidate image. In a case where an instruction to change the selected image to the first candidate image or the second candidate image is received, the display control part 113 may change the selected image corresponding to the one photographing spot icon to the first candidate image or the second candidate image. For instance, the first candidate image is an image captured one frame before the selected image, and the second candidate image is an image captured one frame after the selected image.

In the embodiment, the display control part 113 may be configured to display third multiple photographing spot icons respectively indicating only third multiple photographing spots each belonging to the first multiple photographing spots and being closest to each of the second multiple photographing spots in the route from the photographing start spot to the photographing finish spot. In this configuration, the image processing part 112 may cause the second image information storage part 123 of the memory 12 to store only third multiple images corresponding to the third multiple photographing spots each belonging to the first multiple photographing spots and being closest to each of the second multiple photographing spots in the route from the photographing start spot to the photographing finish spot, and may delete other image.

The image processing part 112 may delete the first image information stored in the first image information storage part 122 at an appropriate timing. For instance, the image processing part 112 may delete the first image information stored in the first image information storage part 122 after at least one of the photographing start spot and the photographing finish spot is changed, or after a selected image corresponding to one photographing spot icon is changed to the first candidate image or the second candidate image. Alternatively, the image processing part 112 may delete the first image information stored in the first image information storage part 122 in response to receipt of an instruction from the user to delete the first image information.

Here, a process by the communication device 40 in the embodiment will be described.

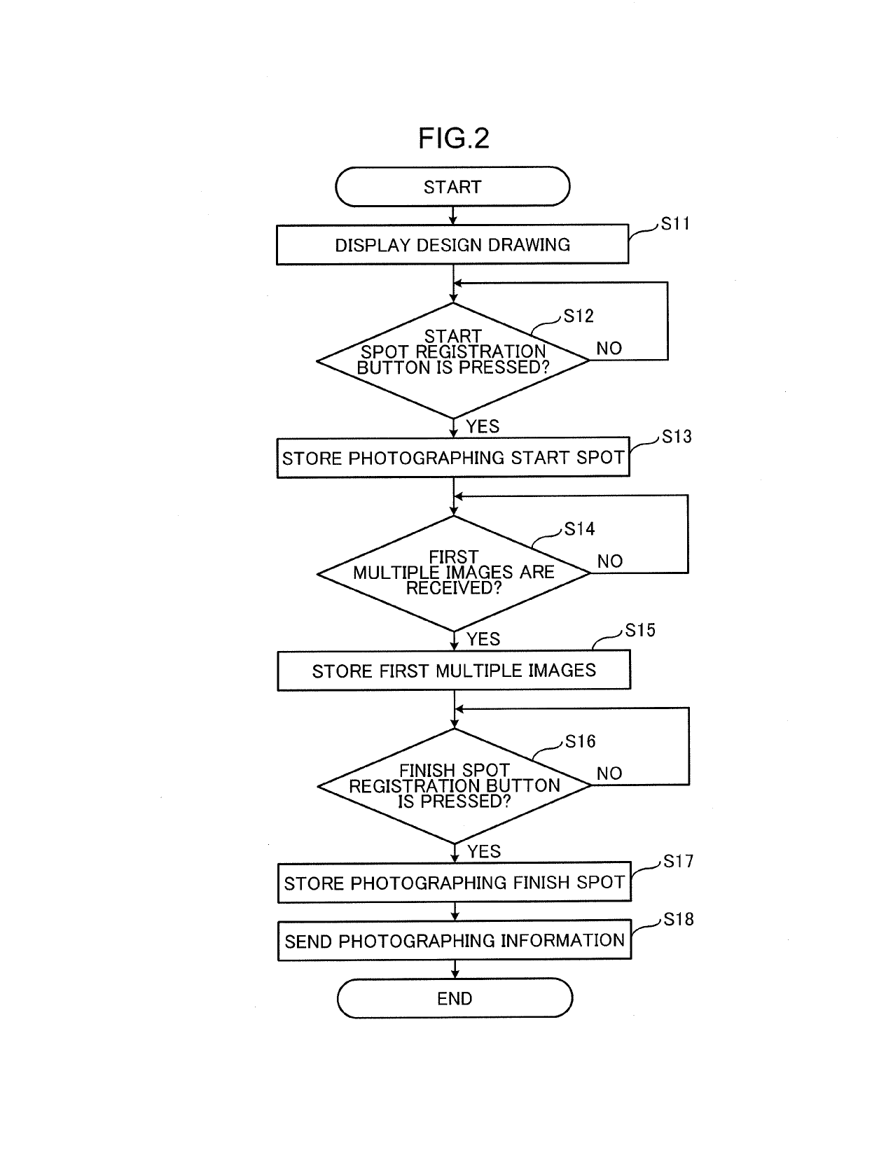

FIG. 2 is a flowchart showing an example of the process by the communication device 40 in the embodiment.

First, in step S11, the communication device 40 displays a design drawing selected by a photographing person. At this time, the communication device 40 receives the selection of the design drawing by the photographing person.

Subsequently, in step S12, the communication device 40 determines whether a start spot registration button is pressed. At this time, the communication device 40 displays the start spot registration button together with the design drawing. The communication device 40 receives input of a start spot position in the design drawing by the photographing person, and receives pressing of the start spot registration button by the photographing person. For instance, the photographing person touches the start spot position in the design drawing being displayed. In this way, the start spot position is input. Then, the photographing person presses the start spot registration button.

The photographing person presses the photographing button of the photographing device 30, after pressing the start spot registration button, to start photographing for an image with the photographing device 30.

When it is determined that the start spot registration button is not pressed (NO in step S12), step S12 is repeated.

In contrast, when it is determined that the start spot registration button is pressed (YES in step S12), the communication device 40 stores, in step S13, a photographing start spot shown in the design drawing. The communication device 40 stores a coordinate of the photographing start spot shown in the design drawing.

Next, in step S14, the communication device 40 determines whether first multiple images are received from the photographing device 30. The photographing person presses the photographing button of the photographing device 30 again to finish the photographing when reaching a photographing finish spot. When the photographing button is pressed, the photographing device 30 sends the captured first multiple images to the communication device 40.

When it is determined that first multiple images are not received from the photographing device 30 (NO in step S14), step S14 is repeated.

In contrast, when it is determined that first multiple images are received from the photographing device 30 (YES in step S14), the communication device 40 stores, in step S15, the received first multiple images.

Subsequently, in step S16, the communication device 40 determines whether a finish spot registration button is pressed. At this time, the communication device 40 displays the finish spot registration button together with the design drawing. The communication device 40 receives input of a finish spot position in the design drawing by the photographing person, and receives pressing of the finish spot registration button by the photographing person. For instance, the photographing person touches the finish spot position in the design drawing being displayed. In this way, the finish spot position is input. Then, the photographing person presses the finish spot registration button.

When it is determined that the finish spot registration button is not pressed (NO in step S16), step S16 is repeated.

In contrast, when it is determined that the finish spot registration button is pressed (YES in step S16), the communication device 40 stores, in step S17, a photographing finish spot shown in the design drawing. The communication device 40 stores a coordinate of the photographing finish spot shown in the design drawing.

Then, in step S18, the second communication device 40 sends photographing information including the first multiple images to the server 10.

Next, an image reduction process by the server 10 in the embodiment will be described.

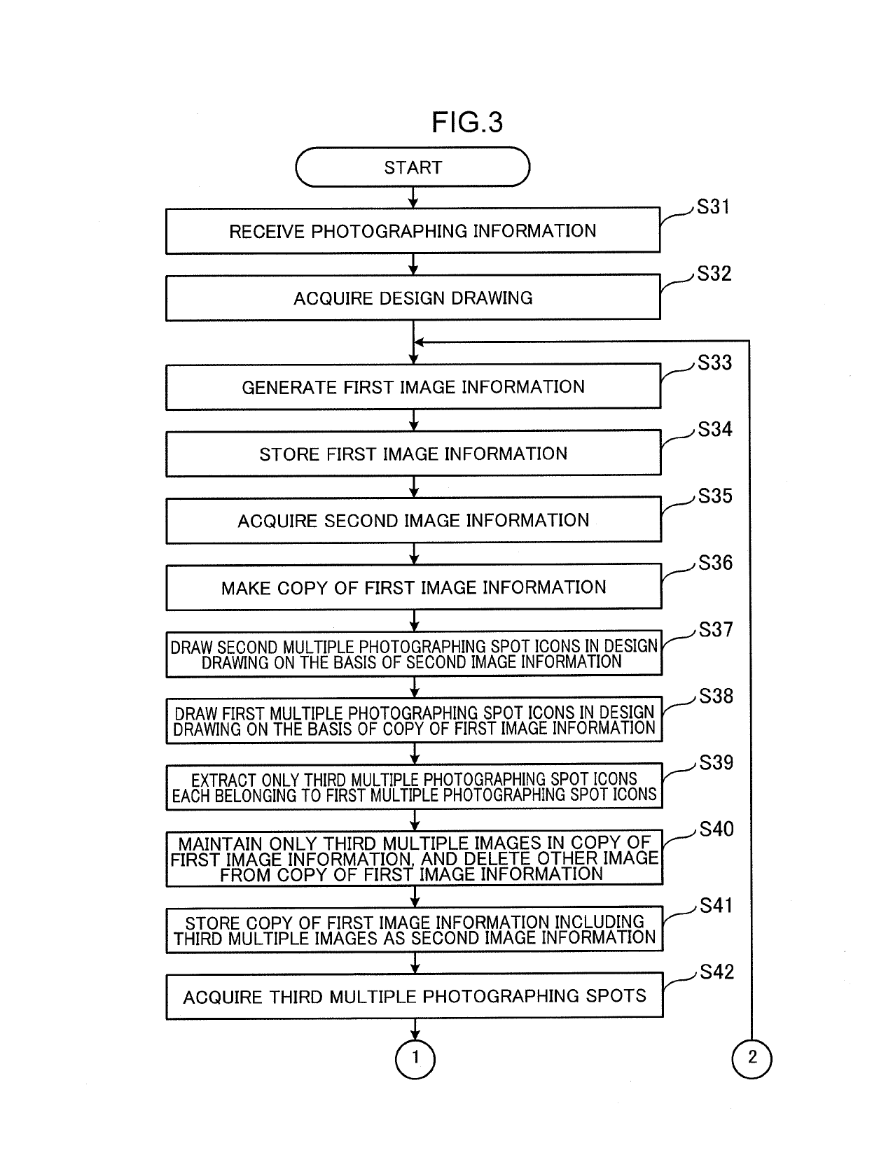

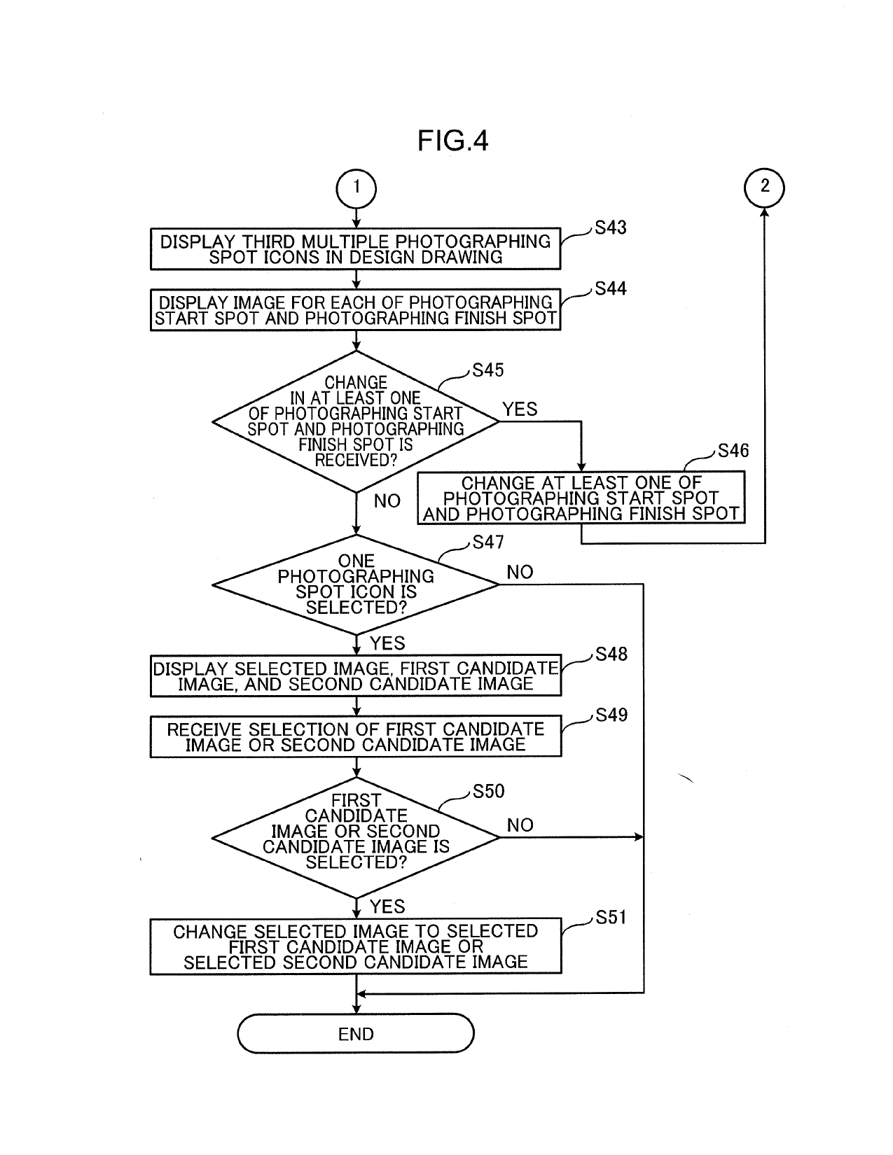

FIG. 3 is a first flowchart showing an example of the image reduction process by the server 10 in the embodiment. FIG. 4 is a second flowchart showing an example of the image reduction process by the server 10 in the embodiment.

First, in step S31, the communication part 13 receives the photographing information sent from the communication device 40.

Subsequently, in step S32, the acquisition part 111 acquires a design drawing from the design drawing information storage part 121. The acquisition part 111 reads out, from the design drawing information storage part 121, such a design drawing corresponding to a design drawing ID included in the photographing information received by the communication part 13.

Then, in step S33, the acquisition part 111 generates first image information on the basis of the photographing information and the design drawing. The acquisition part 111 calculates a photographing spot and a photographing direction shown in the design drawing for each of first multiple images by employing the Visual SLAM technique. The first image information associates the first multiple images captured by the photographing device 30 to be subjected to reduction and meta information about each of the images with each other. The meta information includes a photographing ID, a photographing date and time, a photographing direction, a photographing spot, and a design drawing ID.

Next, in step S34, the image processing part 112 causes the first image information storage part 122 to store the first image information generated by the acquisition part 111.

Subsequently, in step S35, the image processing part 112 acquires, from the second image information storage part 123, second image information including a photographing start spot and a photographing finish spot each falling within a predetermined range from the photographing start spot and the photographing finish spot included in the first image information.

When no second image information is present in the second image information storage part 123, the image processing part 112 receives selection of an image to remain by the user from among the first multiple images. At this time, the image processing part 112 causes the display 23 to display a design drawing, and displays and superimposes, in the design drawing, first multiple photographing spot icons respectively indicating first multiple photographing spots. The image processing part 112 maintains, as second multiple images, only a plurality of images corresponding to the photographing spot icons selected by the user from among the first multiple images respectively corresponding to the first multiple photographing spot icons, and deletes other image. The image processing part 112 causes the second image information storage part 123 to store second image information associating the second multiple images and meta information about each of the second multiple images with each other.

In a case where a plurality of pieces of second image information related to a plurality of photographing dates and times and including respective photographing start spots closer to each other and respective photographing finish spots closer to each other is stored, the image processing part 112 may acquire second image information related to the earliest photographing date and time, or may acquire second image information related to the latest photographing date and time.

Subsequently, in step S36, the image processing part 112 makes a copy of the first image information stored in the first image information storage part 122.

Then, in step S37, the image processing part 112 draws, on the basis of the second image information acquired from the second image information storage part 123, second multiple photographing spot icons respectively indicating second multiple photographing spots in the design drawing.

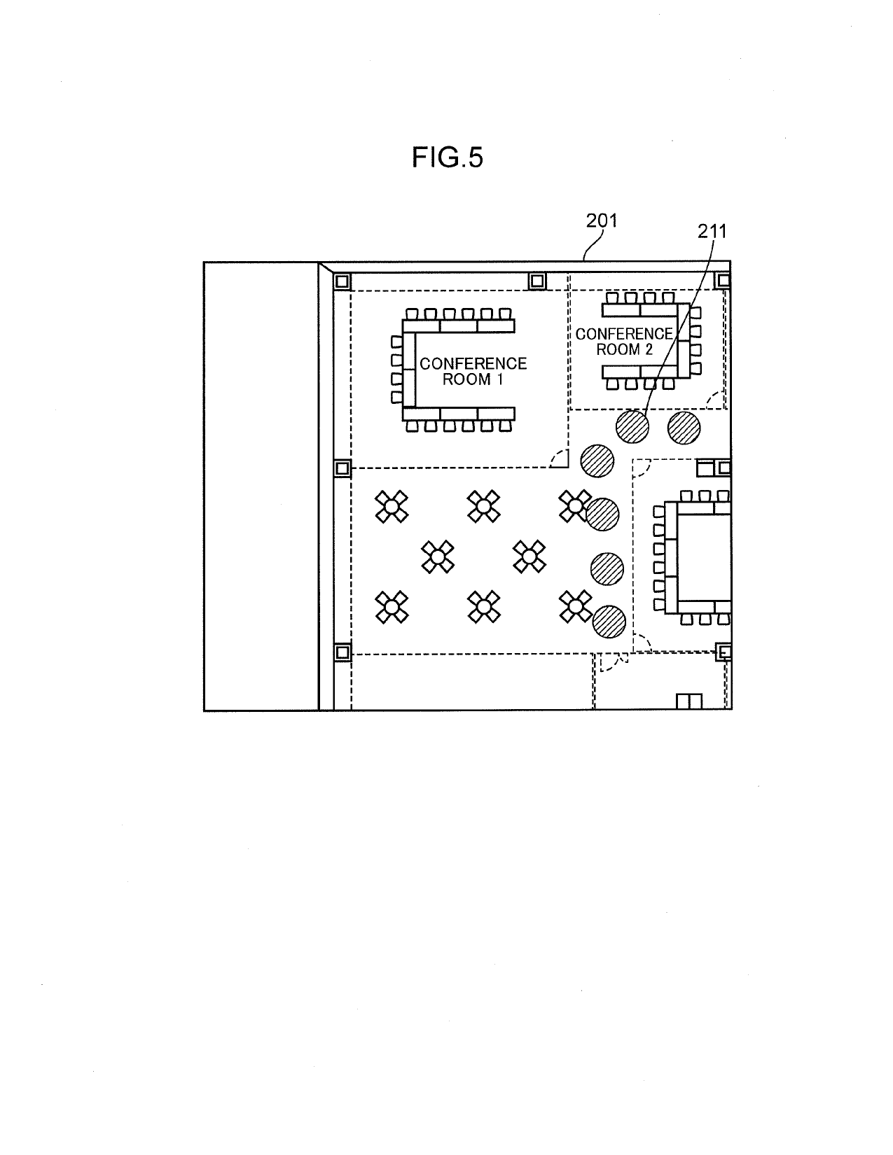

FIG. 5 illustrates a design drawing in which second multiple photographing spot icons are drawn in the embodiment.

In a design drawing 201 illustrated in FIG. 5, second multiple photographing spot icons 211 are superimposed and displayed. Each of the second multiple photographing spot icons 211 indicates a photographing spot related to photographing executed in past. Each of the second multiple photographing spot icons 211 is associated with an image captured at the corresponding photographing spot. In this example, each of the second multiple photographing spot icons 211 includes an image having a circular shape and has a size representing a circle with a diameter of one meter. The second multiple photographing spot icons 211 displayed here respectively correspond to a plurality of photographing spots each belonging to one certain photographing operation. A route from the photographing spot icon at one end (the photographing spot icon located at a lower position in FIG. 5) to the photographing spot icon at another end (the photographing spot icon located at an upper right position in FIG. 2) shows a trace followed by the photographing person in the photographing operation.

Referring back to FIG. 3, next, in step S38, the image processing part 112 draws, on the basis of the made copy of the first image information, first multiple photographing spot icons respectively indicating the first multiple photographing spots in the design drawing.

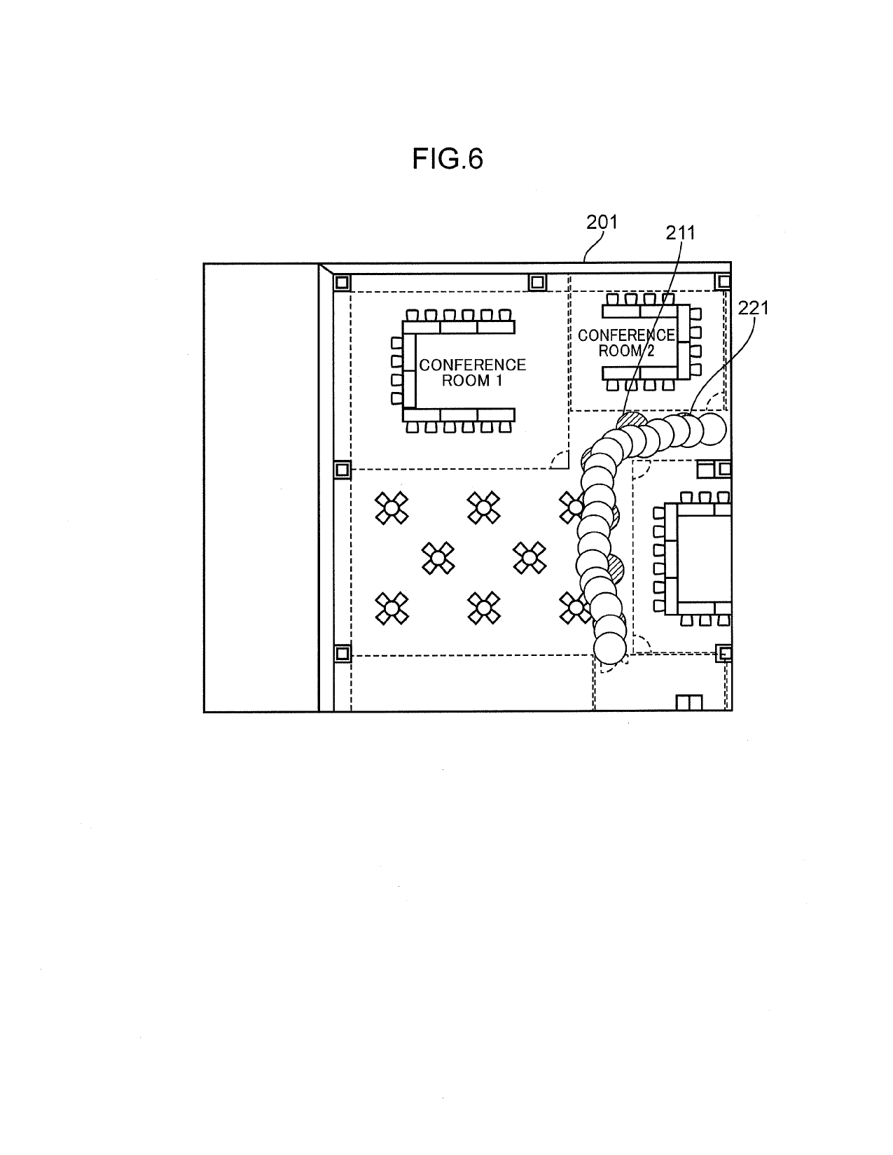

FIG. 6 illustrates the design drawing in which first multiple photographing spot icons and the second multiple photographing spot icons are drawn in the embodiment.

In the design drawing 201 illustrated in FIG. 6, the second multiple photographing spot icons 211 are superimposed, and first multiple photographing spot icons 221 are superimposed. Each of the first multiple photographing spot icons 221 has the same shape and the same size as each of the second multiple photographing spot icons 211. Moreover, a photographing start spot and a photographing finish spot for the first multiple photographing spot icons 221 are substantially the same as those for the second multiple photographing spot icons 211.

The photographing device 30 captures an image at a predetermined frame rate. In this configuration, the number of images is expressed with “frame rate (fps) * photographing time (sec.)”. FIG. 6 shows no reduction in the first multiple images and thus no change in the number of first multiple photographing spot icons 221. Accordingly, the first multiple photographing spot icons 221 are displayed in an overlapping manner along a trace followed by the photographing person.

Referring back to FIG. 3, next, in step S39, the image processing part 112 extracts third multiple photographing spot icons each belonging to the first multiple photographing spot icons, and each overlapping each of the second multiple photographing spot icons in the route from the photographing start spot to the photographing finish spot and having a largest overlapping area therewith.

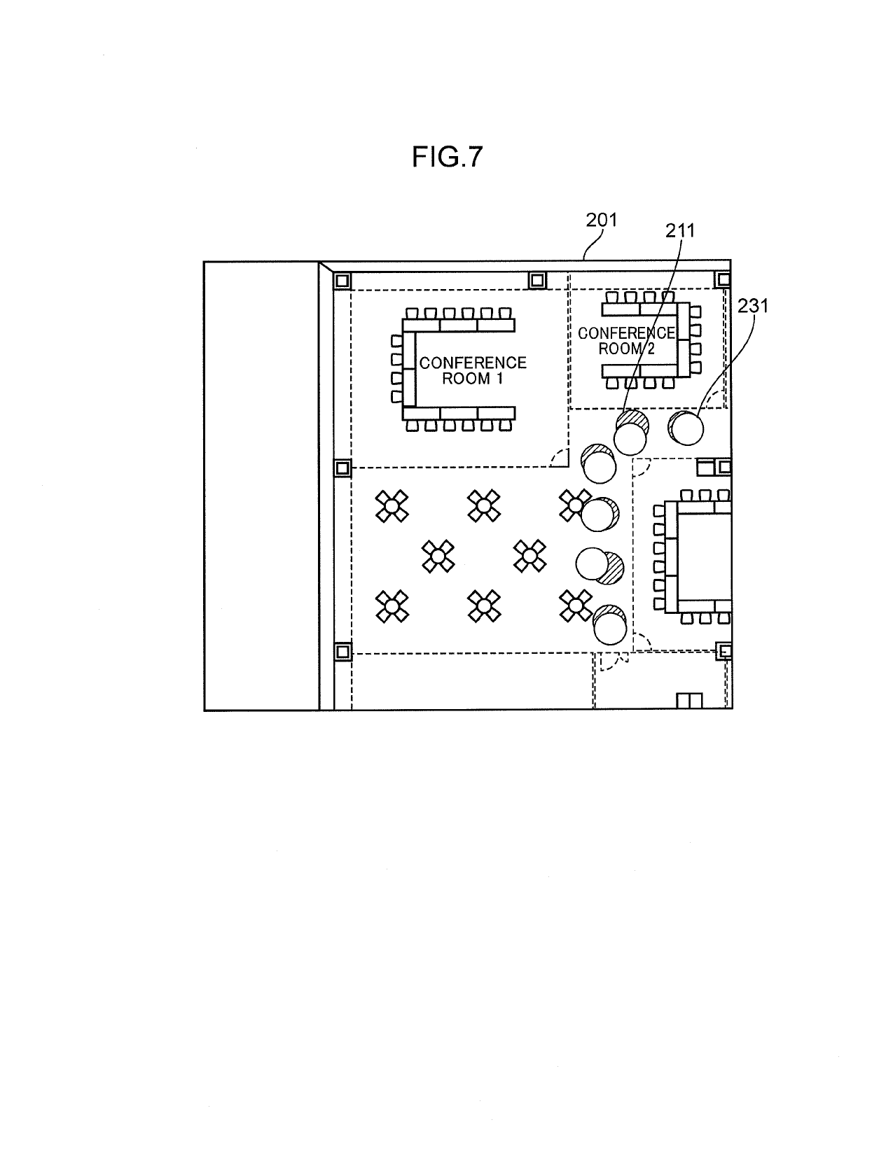

FIG. 7 illustrates third multiple photographing spot icons extracted from the first multiple photographing spot icons on the basis of the second multiple photographing spot icons in the embodiment.

In the design drawing 201 illustrated in FIG. 7, the second multiple photographing spot icons 211 are superimposed, and third multiple photographing spot icon 231 resulting from reduction in the first multiple photographing spot icons 221 are superimposed. Third multiple photographing spot icons 231 each belonging to the first multiple photographing spot icons 221, and each overlapping each of the second multiple photographing spot icons 211 and having a largest overlapping area therewith are extracted. The number of third multiple photographing spot icons 231 is the same as the number of second multiple photographing spot icons 211.

Referring back to FIG. 3, subsequently, in step S40, the image processing part 112 maintains only third multiple images corresponding to the extracted third multiple photographing spot icons in a copy of the first image information, and deletes other image from the copy of the first image information.

Next, in step S41, the image processing part 112 causes the second image information storage part 123 to store, as second image information, the copy of the first image information including the third multiple images resulting from the reduction.

Subsequently, in step S42, the display control part 113 acquires third multiple photographing spots corresponding to the third multiple photographing spot icons extracted from the first multiple photographing spot icons.

Then, in step S43, the display control part 113 sends, to the information terminal 20 via the communication part 13, a display instruction to display, in the design drawing, the third multiple photographing spot icons respectively indicating the third multiple photographing spots, and then displays, in the design drawing being displayed on the display 23 of the information terminal 20, the third multiple photographing spot icons respectively indicating the third multiple photographing spots. At this time, the display control part 113 displays only third multiple photographing spot icons each belonging to the first multiple photographing spot icons, and each overlapping each of the second multiple photographing spot icons in the route from the photographing start spot to the photographing finish spot and having a largest overlapping area therewith.

For instance, the display control part 113 may display, in a display screen image, the design drawing 201 in which the third multiple photographing spot icons 231 illustrated in FIG. 7 are superimposed. The display screen image shows, in the design drawing 201, the third multiple photographing spot icons 231 respectively indicating the third multiple photographing spots.

Next, in step S44, the display control part 113 sends, to the information terminal 20 via the communication part 13, a display instruction to display an image for each of the photographing start spot and the photographing finish spot among the third multiple photographing spots, and then causes the display 23 of the information terminal 20 to display the image for each of the photographing start spot and the photographing finish spot among the third multiple photographing spots.

Here, the user confirms the image for each of the photographing start spot and the photographing finish spot being displayed, and determines whether at least one of the photographing start spot and the photographing finish spot is required to be changed. The display control part 113 is configured to receive a change in at least one of the photographing start spot and the photographing finish spot shown in the design drawing.

Subsequently, in step S45, the display control part 113 determines whether a change in at least one of the photographing start spot and the photographing finish spot is received. When it is determined that a change in at least one of the photographing start spot and the photographing finish spot is received (YES in step S45), the image processing part 112 changes the at least one of the photographing start spot and the photographing finish spot in step S46. The image processing part 112 changes at least one of the photographing start spot and the photographing finish spot among the first multiple photographing spots included in the first image information stored in the first image information storage part 122. Thereafter, the process returns to step S33, and the acquisition part 111 generates first image information again on the basis of the design drawing, the first multiple images, the photographing start spot resulting from the change, and the photographing finish spot resulting from the change. The acquisition part 111 creates first multiple photographing spots being continuous in a series from the photographing start spot to the photographing finish spot in the design drawing again.

In contrast, when it is determined that no change in the photographing start spot and the photographing finish spot is received (NO in step S45), the display control part 113 determines, in step S47, whether one photographing spot icon is selected from among the third multiple photographing spot icons being displayed. When it is determined that one photographing spot icon is not selected (NO in step S47), the process is finished.

In contrast, when it is determined that one photographing spot icon is selected (YES in step S47), the display control part 113 displays, in step S48, a selected image corresponding to the selected one photographing spot icon, a first candidate image captured before the selected image, and a second candidate image captured after the selected image.

Next, in step S49, the display control part 113 receives selection by the user about the first candidate image or the second candidate image being displayed. The user selects the first candidate or the second candidate image to change the selected image to the first candidate image or the second candidate image.

Subsequently, in step S50, the display control part 113 determines whether the first candidate image or the second candidate image is selected. When it is determined that neither the first candidate image nor the second candidate image is selected (NO in step S50), the process is finished.

In contrast, when it is determined that the first candidate image or the second candidate image is selected (YES in step S50), the display control part 113 changes, in step S51, the selected image corresponding to the one photographing spot icon to the selected first candidate image or the selected second candidate image.

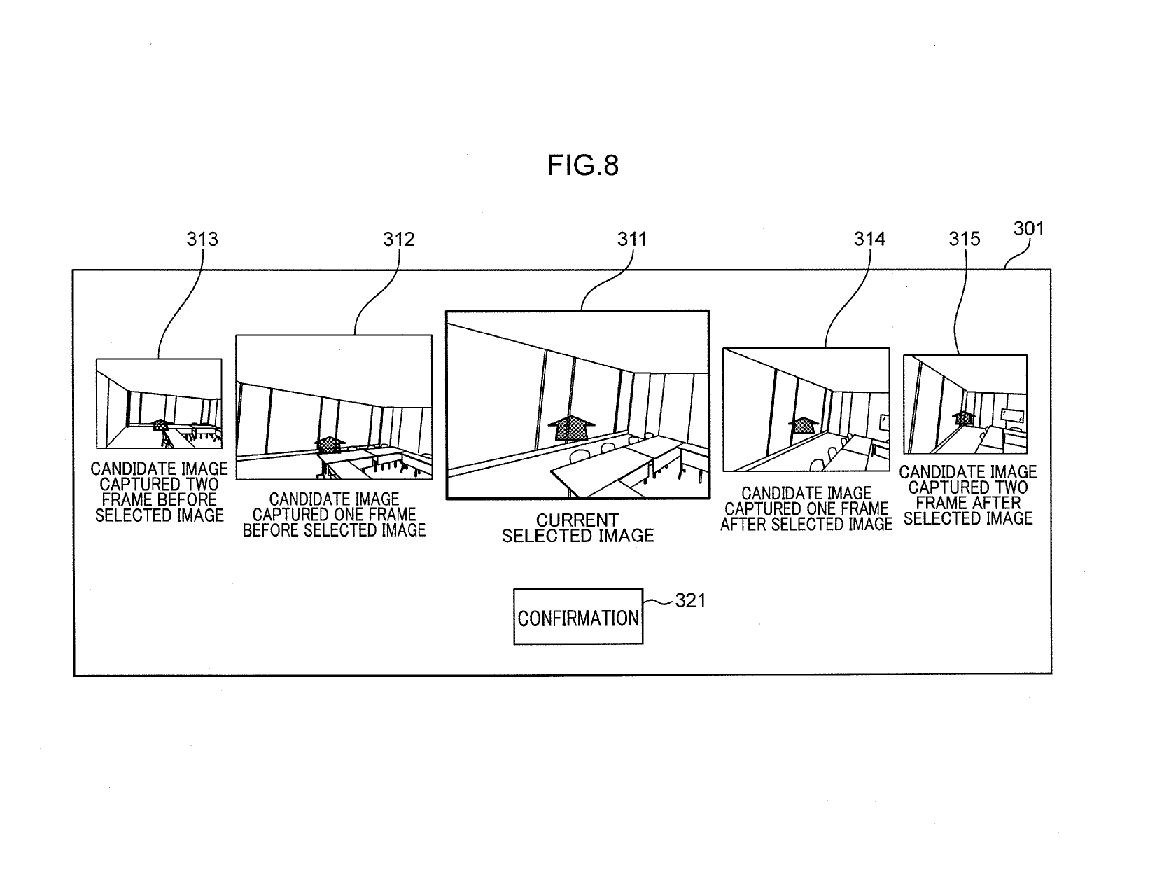

FIG. 8 illustrates an example display screen image to receive a change from a selected image corresponding to one photographing spot icon having been selected.

In a display screen image 301 illustrated in FIG. 8, a current selected image 311 represents a selected image corresponding to one photographing spot icon having been selected, a candidate image 312 captured one frame before the selected image represents a first candidate image captured before the selected image, and a candidate image 314 captured one frame after the selected image represents a second candidate image captured after the selected image. The display screen image 301 shows, in addition to the aforementioned images, a candidate image 313 captured two frame before the selected image and a candidate image 315 captured two frame after the selected image. The user confirms the current selected image 311 being displayed and further confirms the candidate images 312, 313, 314, and 315 being displayed. The user selects one candidate image from among the candidate images 312, 313, 314, and 315, and presses a confirmation button 321 to change the current selected image.

When the one candidate image is selected from among the candidate images 312, 313, 314, and 315, and the confirmation button 321 is pressed, the display control part 113 changes the current selected image 311 corresponding to one photographing spot icon to the one candidate image selected from among the candidate images 312, 313, 314, and 315.

As described above, in the case where the design drawing shows the first multiple photographing spots and the second multiple photographing spots related to photographing executed earlier than a photographing date and time concerning each of the first multiple photographing spots, the configuration maintains only third multiple images respectively captured at third multiple photographing spots each belonging to the first multiple photographing spots and falling within a predetermined range from each of the second multiple photographing spots in a route from a photographing start spot to a photographing finish spot, and deletes other image, and thus achieves a reduction in an image data amount.

Moreover, the configuration maintains only third multiple images respectively captured at the third multiple photographing spots each belonging to the first multiple photographing spots and falling within a predetermined range from each of the second multiple photographing spots, and thus enables fixed-point observation on a construction site or other site.

The reduction in the image data amount in the server 10 leads to achievement in a reduction in an amount of data stored in the memory 12 of the server 10, and further leads to saving of time for sending the data to the information terminal 20.

Next, an image displaying process by the server 10 in the embodiment will be described.

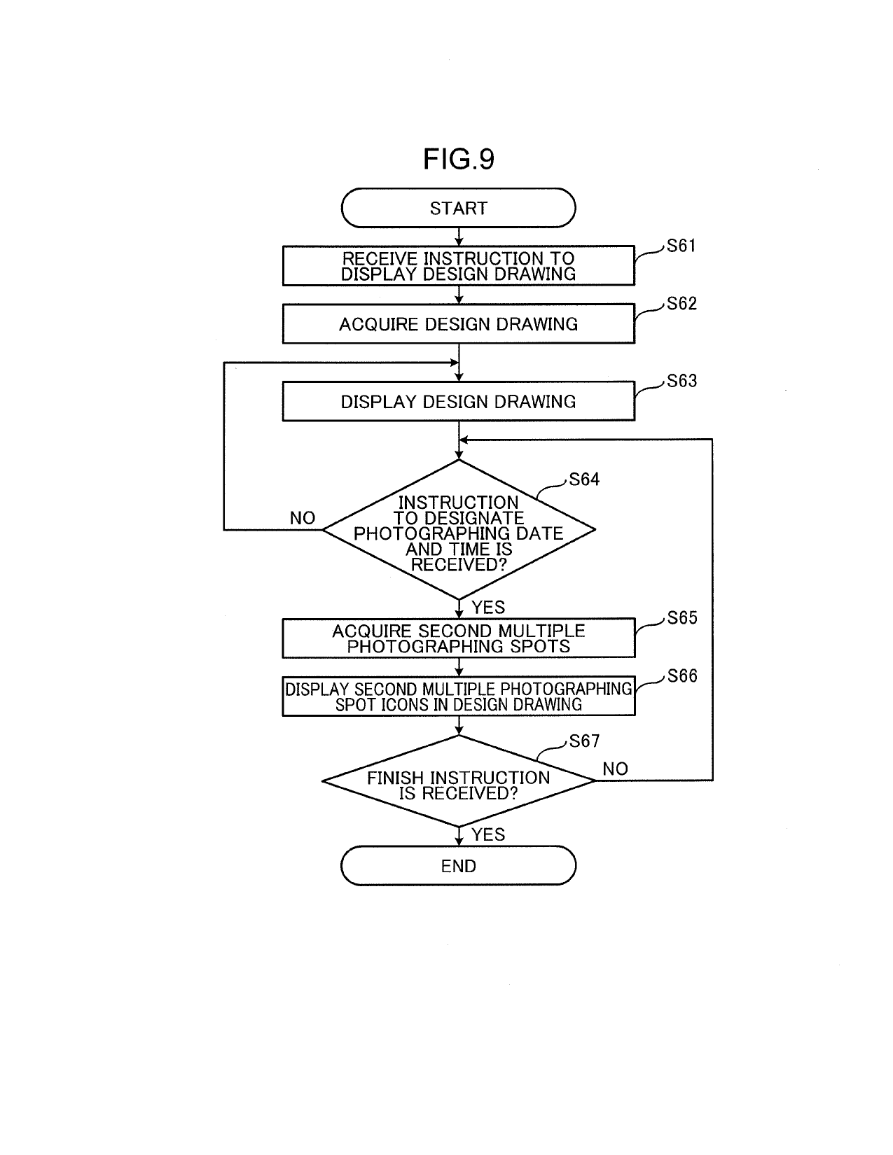

FIG. 9 is a flowchart showing an example of the image displaying process by the server 10 in the embodiment.

First, in step S61, the communication part 13 receives, from the information terminal 20, an instruction to display a design drawing. In this case, the display 23 of the information terminal 20 displays a menu screen image for design drawing selection, and the manipulation part 24 receives an instruction from the user to select one design drawing from the menu screen image. The instruction input in this manner is sent to the server 10 via the network NT and received by the communication part 13. The instruction to display the design drawing contains a design drawing ID.

Subsequently, in step S62, the acquisition part 111 acquires, from design drawing information stored in the design drawing information storage part 121, a design drawing corresponding to the design drawing ID contained in the instruction to display the design drawing received by the communication part 13.

Then, in step S63, the display control part 113 sends display data for the design drawing to the information terminal 20 via the communication part 13, and then causes the display 23 of the information terminal 20 to display the design drawing. A display screen image displayed as a default shows the design drawing selected in step S61 and a selection receipt field to select a photographing date and time. The selection receipt field shows photographing dates and times being available for displaying and thus displayed in a selectable manner, and the manipulation part 24 receives an instruction from the user to select a desired photographing date and time in the selection receipt field. Each photographing date and time shown in the selection receipt field indicates a representative value of a photographing date and time included in the image information stored in the memory 12. Examples of the representative value include a photographing start date and time. Selection of the photographing date and time leads to selection of one photographing operation concerning the photographing date and time. The instruction to designate the photographing date and time is sent to the server 10 via the network NT and received by the communication part 13. The instruction to designate the photographing date and time contains a photographing ID.

Next, in step S64, the acquisition part 111 determines whether the communication part 13 receives an instruction to designate a photographing date and time. When it is determined that the communication part 13 receives no instruction to designate a photographing date and time (NO in step S64), the process returns to step S63.

In contrast, when it is determined that the communication part 13 receives an instruction to designate a photographing date and time (YES in step S64), the acquisition part 111 acquires, from the second image information stored in the second image information storage part 123, second multiple photographing spots each corresponding to the photographing ID contained in the instruction to designate the photographing date and time received by the communication part 13, in step S65.

Subsequently, in step S66, the display control part 113 sends, to the information terminal 20 via the communication part 13, a display instruction to display, in the design drawing, second multiple photographing spot icons respectively indicating the second multiple photographing spots, and then displays, in the design drawing being displayed on the display 23 of the information terminal 20, the second multiple photographing spot icons respectively indicating the second multiple photographing spots. For instance, the display control part 113 causes the display 23 to display the design drawing 201 illustrated in FIG. 7.

In a case where a plurality of pieces of second image information including substantially the same photographing start spot and substantially the same photographing finish spot is stored, the display control part 113 may superimpose and display second multiple photographing spot icons respectively for the pieces of second image information, or display second multiple photographing spot icons for only the designated second image information.

Then, in step S67, the acquisition part 111 determines whether the communication part 13 receives a finish instruction. The finish instruction is an instruction to close the design drawing displayed in the step S63. The instruction is input in response to a manipulation to press a finish button (not shown) displayed on the display 23. When it is determined that the communication part 13 receives a finish instruction (YES in step S67), the process is finished. In contrast, when it is determined that the communication part 13 does not receive a finish instruction (NO in step S67), the process returns to step S64. In this case, the displaying of the design drawing is maintained. The finish instruction is sent to the server 10 via the network NT and received by the communication part 13. The acquisition part 111 acquires the finish instruction via the communication part 13.

Although the image processing part 112 receives deletion of first multiple images by the user in absence of second multiple images at acquisition of first multiple images in the embodiment, the present disclosure is not particularly limited thereto. The image processing part 112 may automatically delete first multiple images.

Specifically, first, the image processing part 112 acquires a reference image from among the first multiple images. The reference image is an image captured at a photographing start spot. Next, the image processing part 112 acquires a comparative image captured at a later time than the reference image from among the first multiple images. The comparative image is an image captured at a subsequent frame to the reference image. Subsequently, the image processing part 112 extracts a first feature point and a second feature point respectively from a first region and a second region resulting from horizontally dividing the reference image. Then, the image processing part 112 extracts a third feature point and a fourth feature point respectively from a first region and a second region resulting from horizontally dividing the comparative image. Next, the image processing part 112 calculates a first change amount from a position of the first feature point to a position of the third feature point. Subsequently, the image processing part 112 calculates a second change amount from a position of the second feature point to a position of the fourth feature point. When at least one of the first feature amount and the second feature amount has a threshold or higher, the image processing part 112 makes the memory 12 store the comparative image as the second image information. In contrast, when each of the first change amount and the second change amount does not have the threshold or higher, the image processing part 112 deletes the comparative image.

When the comparative image is deleted, the image processing part 112 acquires, as a comparative image, an image at a subsequent flame to the deleted comparative image, calculates a first change amount and a second change amount, and determines whether to make the memory 12 store the acquired comparative image on the basis of the calculated first change amount and the calculated second change amount. When the comparative image stored in the memory 12 as the second image information, the image processing part 112 acquires the stored comparative image as the reference image. The image processing part 112 then acquires an image at a subsequent frame to the acquired reference image as a comparative image, calculates a first change amount and a second change amount, and determines whether to make the memory 12 store the acquired comparative image on the basis of the calculated first change amount and the calculated second change amount. The image processing part 112 repeats the operation from acquisition of a reference image to storage or deletion of a comparative image, until an image captured at a certain photographing finish spot is acquired as the comparative image and it is finally determined whether to make the memory 12 store the comparative image. This results in reduction in the first multiple images captured by the photographing device 30.

The technology according to the present disclosure achieves a reduction in an image data amount, and thus is useful as a technology to display an image.

1. An information processing method to be executed by a computer, comprising:
displaying a bird’s-eye view on a display of an information terminal; and
displaying, in the bird’s-eye view, a plurality of photographing spot icons respectively indicating a plurality of photographing spots being continuous in a series from a photographing start spot to a photographing finish spot, wherein
the photographing spot icons are respectively associated with a plurality of images captured at the photographing spots, and
the displaying of the photographing spot icons includes, in a case where the bird’s-view shows first multiple photographing spots and second multiple photographing spots related to photographing executed earlier than a photographing date and time concerning each of the first multiple photographing spots, displaying third multiple photographing spot icons respectively indicating third multiple photographing spots each belonging to the first multiple photographing spots and falling within a predetermined range from each of the second multiple photographing spots in a route from the photographing start spot to the photographing finish spot.

2. The information processing method according to claim 1, wherein
the displaying of the photographing spot icons includes drawing, in the bird’s-eye view, first multiple photographing spot icons respectively indicating the first multiple photographing spots and second multiple photographing spot icons respectively indicating the second multiple photographing spots, and displaying only third multiple photographing spot icons each belonging to the first multiple photographing spot icons and overlapping each of the second multiple photographing spot icons in the route from the photographing start spot to the photographing finish spot.

3. The information processing method according to claim 2, wherein
the displaying of the photographing spot icons includes displaying only third multiple photographing spot icons each belonging to the first multiple photographing spot icons, and each overlapping each of the second multiple photographing spot icons and having a largest overlapping area therewith in the route from the photographing start spot to the photographing finish spot.

4. The information processing method according to claim 1, wherein
the displaying of the photographing spot icons includes displaying third multiple photographing spot icons respectively indicating only third multiple photographing spots each belonging to the first multiple photographing spots and being closest to each of the second multiple photographing spots in the route from the photographing start spot to the photographing finish spot.

5. The information processing method according to claim 1, further comprising
storing, in a memory, only third multiple images each belonging to first multiple images respectively captured at the first multiple photographing spots, the third multiple images being respectively captured at the third multiple photographing spots each falling within the predetermined range from each of the second multiple photographing spots in the route from the photographing start spot to the photographing finish spot, and deleting other image.

6. The information processing method according to claim 1, further comprising:
making copies of first multiple images respectively captured at the first multiple photographing spots; and
storing, in a memory, only third multiple images each included in the copies of the first multiple images and respectively captured at the third multiple photographing spots each falling within the predetermined range from each of the second multiple photographing spots in the route from the photographing start spot to the photographing finish spot, and deleting other image.

7. The information processing method according to claim 1, further comprising,
creating, in a case where a change in the photographing start spot and the photographing finish spot by a user is received, first multiple photographing spots being continuous in a series from a photographing start spot to a photographing finish spot in the bird’s-eye view, on the basis of the bird’s-eye view, the images, the photographing start spot resulting from the received change, and the photographing finish spot resulting from the received change;
creating, in a case where a change in the photographing start spot by a user is received, first multiple photographing spots being continuous in a series from a photographing start spot to a photographing finish spot in the bird’s-eye view, on the basis of the bird’s-eye view, the images, the photographing start spot resulting from the received change, and the photographing finish spot; and
creating, in a case where a change in the photographing finish spot by a user is received, first multiple photographing spots being continuous in a series from a photographing start spot to a photographing finish spot in the bird’s-eye view, on the basis of the bird’s-eye view, the images, the photographing start spot, and the photographing finish spot resulting from the received change.

8. The information processing method according to claim 1, further comprising:
displaying, in a case where selection of one photographing spot icon by the user from among the third multiple photographing spot icons being displayed is received, a selected image corresponding to the selected one photographing spot icon, a first candidate image captured before the selected image, and a second candidate image captured after the selected image; and
changing, in a case where an instruction to change the selected image to the first candidate image or the second candidate image is received, the selected image corresponding to the one photographing spot icon to the first candidate image or the second candidate image.

9. An information processing device, comprising:
a processor,
the processor being configured to:
display a bird’s-eye view on a display of an information terminal; and
display, in the bird’s-eye view, a plurality of photographing spot icons respectively indicating a plurality of photographing spots being continuous in a series from a photographing start spot to a photographing finish spot, wherein
the photographing spot icons are respectively associated with a plurality of images captured at the photographing spots, and
in the displaying of the photographing spot icons, in a case where the bird’s-eye view shows first multiple photographing spots and second multiple photographing spots related to photographing executed earlier than a photographing date and time concerning each of the first multiple photographing spots, third multiple photographing spot icons are displayed, the third multiple photographing spot icons respectively indicating third multiple photographing spots each belonging to the first multiple photographing spots and falling within a predetermined range from each of the second multiple photographing spots in a route from the photographing start spot to the photographing finish spot.

10. A non-transitory computer readable recording medium storing an information processing program, comprising
causing a computer to:
display a bird’s-eye view on a display of an information terminal; and
display, in the bird’s-eye view, a plurality of photographing spot icons respectively indicating a plurality of photographing spots being continuous in a series from a photographing start spot to a photographing finish spot, wherein
the photographing spot icons are respectively associated with a plurality of images captured at the photographing spots, and
in the displaying of the photographing spot icons, in a case where the bird’s-eye view shows first multiple photographing spots and second multiple photographing spots related to photographing executed earlier than a photographing date and time concerning each of the first multiple photographing spots, third multiple photographing spot icons
are displayed, the third multiple photographing spot icons respectively indicating third multiple photographing spots each belonging to the first multiple photographing spots and falling within a predetermined range from each of the second multiple photographing spots in a route from the photographing start spot to the photographing finish spot.
